(19) United States
(12) Patent Application Publication
(10) Pub. No.: US 2005/0273474 A1
(43) Pub. Date: Dec. 8, 2005

(54) Method and system for data processing with data replication for the same

(76) Inventors: Nobuo Kawamura, Atsugi (JP); Taichi Ishikawa, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/078,373

(22) Filed: Mar. 14, 2005

Related U.S. Application Data
(63) Continuation-in-part of application No. 10/932,100, filed on Sep. 2, 2004.

(30) Foreign Application Priority Data
Jun. 3, 2004 (JP) 2004-165250
Dec. 9, 2004 (JP) 2004-357028

(51) Int. Cl. G06F 12/00

(52) U.S. Cl. 707/200

(57) ABSTRACT

A replication data base is created on the basis of a predetermined condition. A data processing system adds transactions that are lacking and/or cancels transactions that are not required, to and from a replication data base created on the basis of a certain arbitrary time, in accordance with a predetermined condition defined by the data base user.

### CROSS-REFERENCE TO PRIOR APPLICATION

This is a continuation-in-part of U.S. Ser. No. 10/932,100, filed Sep. 2, 12004, the entire contents of which is incorporated herein by reference.

This application relates to and claims priority from Japanese Patent Application No. 2004-165250, filed on Jun. 3, 2004, and Japanese Patent Application No. 2004-357028, filed on Dec. 9, 2004 the entire disclosure of which are incorporated herein by reference.

### BACKGROUND OF THE INVENTION

The present invention relates to a data processing technology for making a data replication.

In an online work that conducts a lot of transactions, aggregation of a large amount of data, which requires daily or monthly operations, and the like, are obstructive to a 24-hour continuous operation. In other words, the batch processing for these works, which involves a batch access to the data base that is used in the online work, has a considerable effect on online work processing.

As a solution thereof, a method is known, as disclosed in for example JP-A-2000-347811, in which a plurality of data management systems are placed on LAN (Local Area Network)/WAN (Wide Area Network), and an update content of the data base which is used in the online work is always transmitted and copied to another data base management system via a network, thus a replication of a data base for the online work being provided. It is possible to prevent burdens from falling on the online work side too much and to conduct the online work in parallel with batch processing by performing the foregoing batch processing on the replication data base side.

Another method is also known which utilizes a SAN (Storage Area Network) configuration, which has become widespread in recent years for general storage devices, or a configuration in which a plurality of external storage devices, such as a magnetic disc device and the like, are organically connected via a dedicated high speed network, to provide a replication (or may be referred to as a replica, a snap shot, or a shadow image) of the data base for the online work.

In the configuration, the external storage device, such as a storage device or the like, provides: a function of copying rapidly an arbitrary logical volume to (one or) a plurality of logical volumes; a function of performing multiple write of data assuming the arbitrary logical volume as an original volume and the (one or a) plurality of logical volumes as a duplicate volume; a function of separating the logical volumes which are in a state of multiple write at an arbitrary point in time to allow the volumes to be accessed as an independent original or duplicate volume; and the like. In the data base replication created in such a scheme, the data base is copied to the data base replication based on a certain arbitrary time when the pair of the original and duplicate volumes was released. Therefore, transactions, which were conducted before that release time are copied.

### SUMMARY OF THE INVENTION

In the prior art described above, a replication of the data base (hereafter, also called “replication data base”) is created on the basis of a certain arbitrary time. However, normally, a transaction takes a certain length of time to process, and the time period taken to complete a transaction process may span the reference time. Therefore, it is difficult to divide up transactions on the basis of a time indicated by the timer in the computer. For example, it is desirable to create a replication data base on the basis of a work requirement which requires that transactions handled on that day are copied, and transactions to be handled on the next day are not copied. More specifically, it is desirable to create a replication data base which assures that work is in a state of completion, including, for example, slip data processing transactions up to and including those handled on that day.

Further, it is desirable to utilize an added function, such as a high-speed copying function which is possessed by the external storage device, or the like, a prescribed communications environment (such as a SAN environment).

It is an object of the present invention to create a replication data base based on a predetermined condition. It is another object of the present invention to define the predetermined condition for the user of the data base in an arbitrary way. It is still another object to provide an information processing apparatus that has a system having a function of making a selection in accordance with the predetermined condition as to whether or not to copy the operation of data base operation processing carried out for each transaction, to a replication data base.

In order to achieve the above objects, in a data processing method according to one aspect of the present invention, a transaction, which is not included in the replication data base created based on the certain arbitrary time, is added to the replication data base, and/or an unnecessary transaction is removed from the data base replication in accordance with the predetermined condition defined by the data base user.

According to the present invention, it is possible to create a replication data base on the basis of a predetermined condition.

### BRIEF DESCRIPTION OF THE DRAWINGS

FIG. 1 is a diagram showing a system configuration of a first embodiment;

FIG. 2 is a diagram showing a time chart of the first embodiment;

FIG. 3 is a table showing a configuration of an update log file of the first embodiment;

FIG. 4 is a transaction management table of the first embodiment;

FIG. 5 is a diagram showing a configuration of a data base of the first embodiment;

FIG. 6 a diagram showing transaction selection processing of the first embodiment;

FIG. 7 a diagram showing transaction selection processing of the first embodiment;

FIG. 8 is a diagram showing finally updated transaction search processing of the first embodiment;

FIG. 9 is a diagram showing cancellation transaction selection processing of the first embodiment;

FIG. 10 is a diagram showing an additional transaction selection processing of the first embodiment;

FIG. 11 is a diagrams showing transaction cancellation processing of the first embodiment;

FIG. 12 is a diagram showing transaction addition processing of the first embodiment;

FIG. 13 is a diagram showing a detail of transaction cancellation processing of the first embodiment;

FIG. 14 is a diagram showing a system configuration of a second embodiment;

FIG. 15 is a diagram showing a DB-disk configuration of the second embodiment;

FIG. 16 is a DB-disk block conversion table of the second embodiment; and

FIG. 17 shows a time chart of a third embodiment.

FIG. 18 shows an example of the configuration of a data processing system relating to a fourth embodiment of the present invention.

FIG. 19 shows one example of a processing sequence implemented in a data processing system relating to a fourth embodiment of the present invention.

FIG. 20 is an illustrative diagram of a method for creating a separation point between data represented by a time series in a data base, by using a timing table.

FIG. 21 shows an example of the configuration of an exclusive management table.

### DESCRIPTION OF THE EMBODIMENTS

Embodiments of the present invention will be described in detail below with reference to drawings.

### Embodiment 1

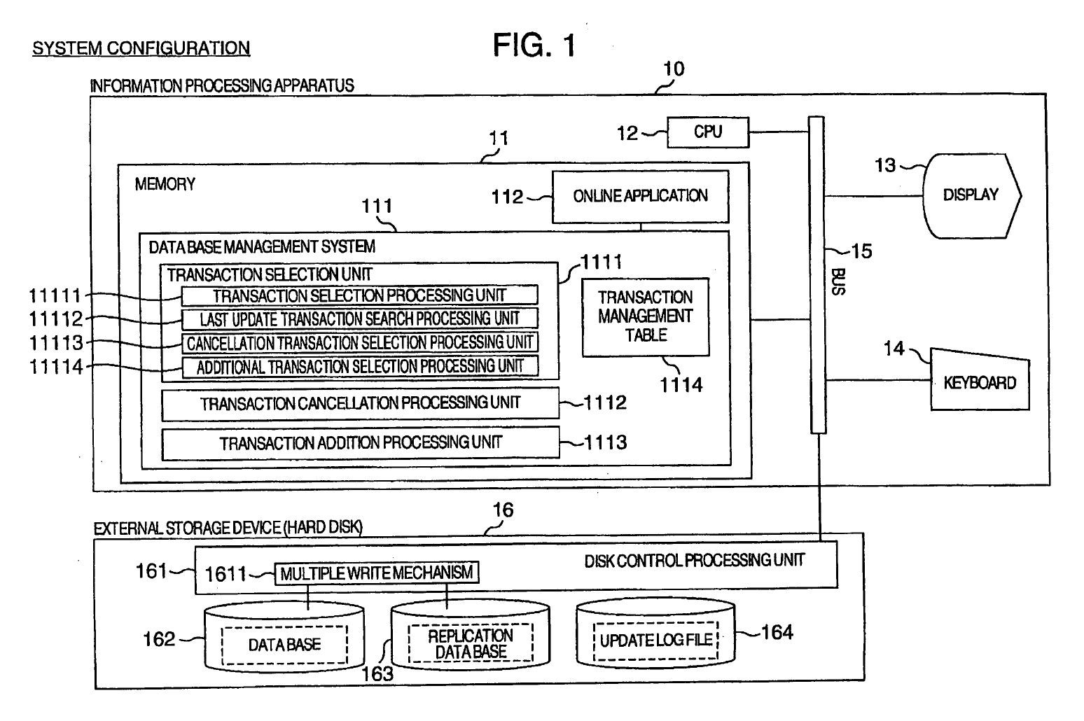

FIG. 1 shows a system configuration of an information processing apparatus of an embodiment according to the present invention. In the embodiment, the system configuration is implemented by an information processing apparatus 10 and an external storage device 16 which are connected by a bus 15. The information processing apparatus 10 comprises a CPU 12, a memory 11, a display 13, and a keyboard 14. An online application (a business program or a program is also acceptable) 112 accesses a data base 162 on the external storage device 16 via a data management system 111. An update content of the data base 162 can be recorded on an update log file 164 as update history information, and can also be copied to a replication data base 163 by a multiple write mechanism 1611 which is on a disk control processing unit 1661.

The multiple write mechanism 1611 can also release the multiple write or synchronization at an arbitrary point in time. In other words, it can also record the content of the data base 162 on the replication data base 163 to allow the replication data base 163 to be read and written independently from the data base 162 via the data base management system 111. The data base management system 111 comprises: a transaction selection processing unit 1111 for selecting a transaction that meets a certain condition from the update log file 164; a transaction management table 1114 for managing the transaction; a transaction cancellation processing unit 1112 for canceling a transaction that does not meet the condition from the replication data base 163; and a transaction addition processing unit 1113 for adding a transaction that meets the condition to the replication data base 163. The transaction selection processing unit 1111 comprises: a transaction selection processing unit 111111; a last updated transaction search processing unit 11112; a cancellation transaction selection processing unit 11113; and an additional transaction selection processing unit 11114. The foregoing each processing unit, mechanism, and system can be implemented by a program, an object, a process, a thread, and hardware. While the data base management system has been described by way of an example in the present embodiment, the present invention is not limited thereto. It is applicable to general data processing that uses log information to perform failure recovery, as well as to a transaction monitor and a file system.

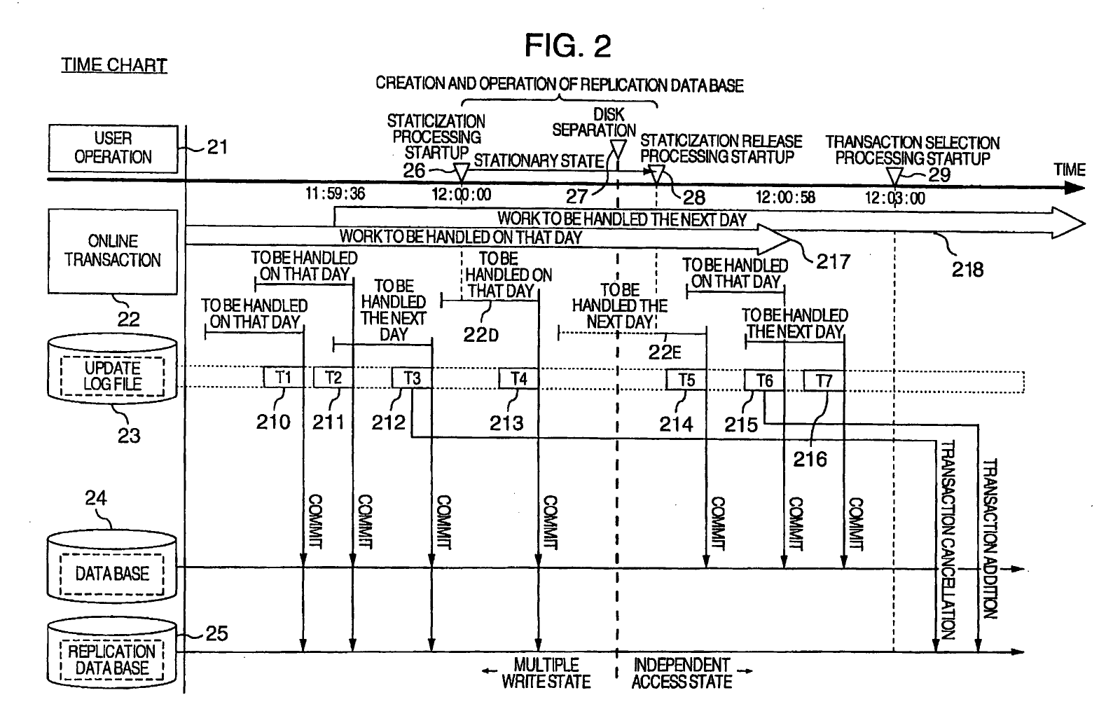

FIG. 2 is a time chart explaining a flow of creation processing of a replication data base that uses transaction selection processing. It shows a variation with time concerning how an update log file 23, a data base 24, and a replication data base 25 are updated by an online transaction 22 and a user operation 21.

The uppermost time axis in FIG. 2 indicates the work time (for example, the internal time of the computer which copies the transactions to the data base 24). The arrows 217 and 218 in FIG. 2 show which work hour the transactions belong to. For example, they indicate the date and time of a time-stamp which is attached to a prescribed type of transaction log (for instance, INSERT). The ranges indicated by the reference numerals 22D and 22E in FIG. 2 are the length of time taken to process the transactions. For example, in the transaction processing 22D, if a COMMIT log is generated, then the transaction 213 in that transaction processing is registered in the data base 24. Furthermore, if the data base 24 and the replication data base 25 are paired, then the external storage device 16 duplicates the transaction 213 and stores the duplicated transaction 213 respectively in the data base 24 and the replication data base 25. As described hereafter, the data base management system 111 is able to specify which work hour (for example, the current day's work or the next day's work) the stored transaction 213 belongs to, by referring to the post-update data corresponding to the INSERT log, of the plurality of types of log relating to the transaction 213. This is because a certain computer (for example, the data base management system 111 or an online application 112 processed by same) attaches a time stamp indicating the work date and time of the transaction 213 to the post-update data corresponding to the INSERT log.

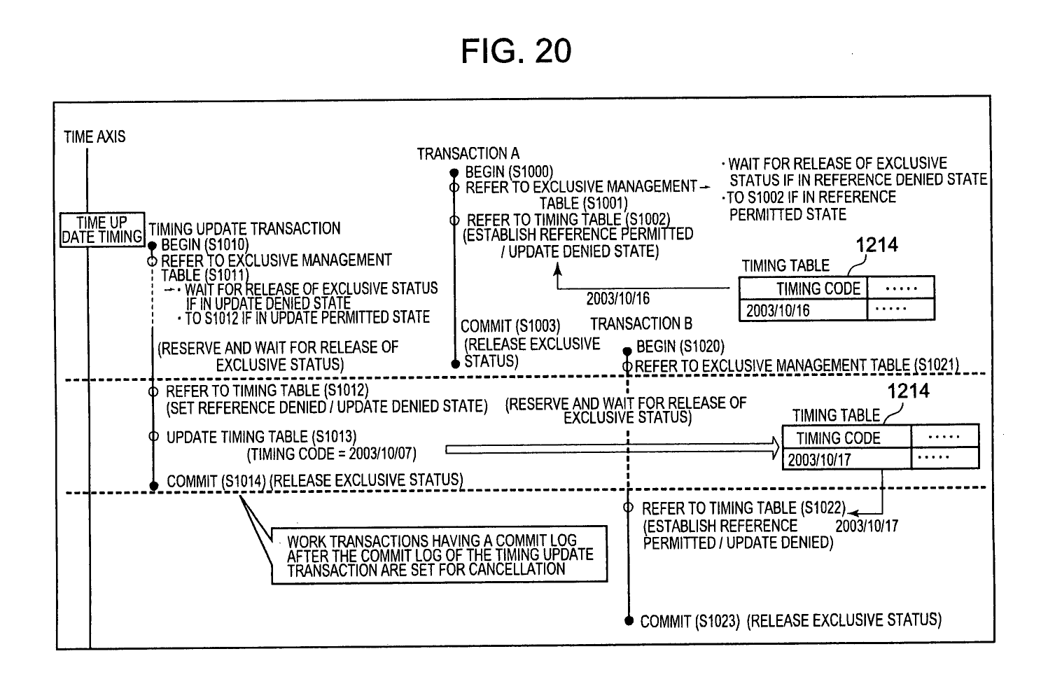

The time stamp attached here may be the date and time indicated by the internal timer of the computer providing the data base management system 111, or it may be a time code relating to a timing table 1214, which is described hereafter with reference to FIG. 20. This also applies to the fourth embodiment described below.

Update contents of online transactions 210, 211, 212, and 213 are copied to the data base 24 and replication data base 25 by the multiple write mechanism 1611. In other words, during the time until the information processing apparatus 10 makes a separation request 27 to the external storage device 16, the update content of the data base 24 is also copied to the replication data base 25. In this manner, the content of the replication data base 25 is kept updated. In other words, until a disk separation request 27 is issued, the replication data base 25 is updated in synchronization with updating of the data base 24 (namely, the contents of the replication data base 25 are kept the same as the contents of the data base 24). When a disk separation request 27 has been issued, the replication data base 25 is not updated, even if the data base 24 is updated.

Furthermore, after the information processing apparatus 10 makes the disk separation request 27, or a pair release request to the external storage device 16 at an arbitrary time, it becomes possible to access the replication data base independently. More specifically, the update content of the transactions 214, 215, and 216, which are started after the disk is separated, is applied only to the data base 24, and not to the replication data base 25. In this manner, it is possible to create the replication data base 25 that includes the update content until an arbitrary time. It should be noted that the update of the data base 24 by the information processing apparatus 10, as stated above, is referred to as an application of update, while a change in the data of the replication data base 25 is referred to as a copy of the update content.

At a timing before disk separation, the user may also make a request to the data base management system 111 asking for a startup of data staticization processing 26 so as to keep the consistency with the transaction of the replication data base 25. Upon receiving the request for startup of data staticization processing 26, the data base management system 111 waits until the transaction processing 22D, which has already been started at the time of the request, completes. When the transaction processing 22D completes, the data base 24 changes to a stationary state. The execution of the transaction processing 22E, which was newly started against the data base 24 that changed from the start of staticization to a stationary state, is kept waiting by the data base management system 111. In other words, the transaction, which is being processed, is eliminated by changing the data base 24 to a stationary state, thus making it possible to maintain the consistency with the transaction of the replication data base 25. Moreover, it is possible to minimize the wait state of the online transaction 22 by quickly releasing 28 the stationary state after the disk separation request 27 was made.

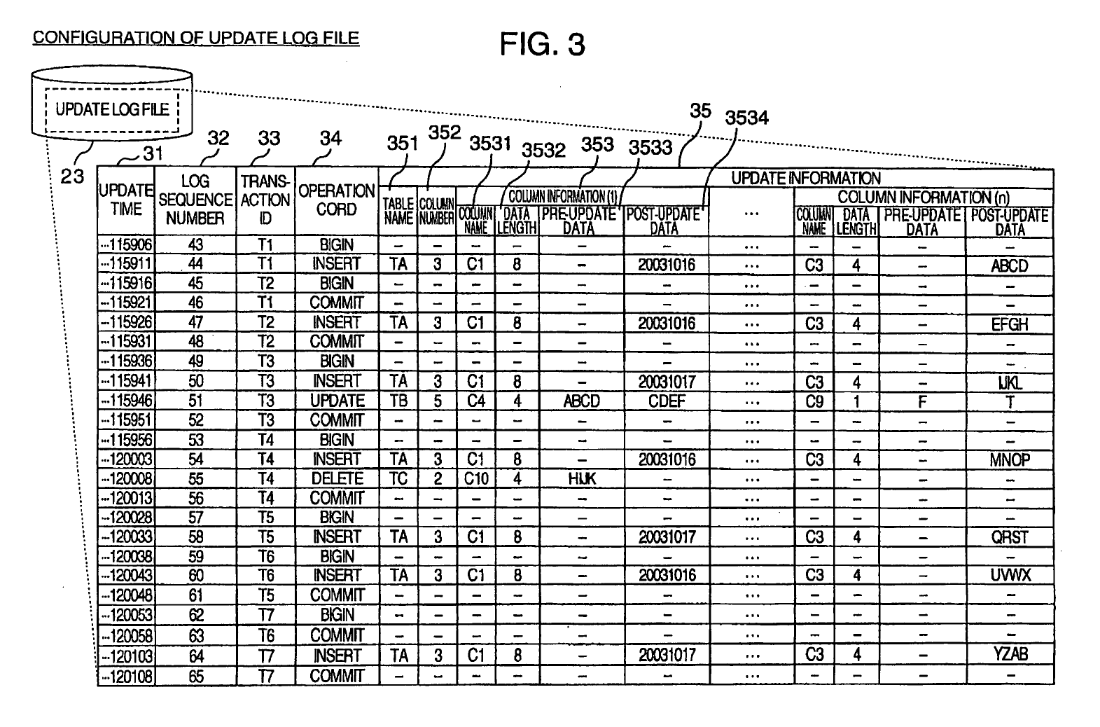

In the embodiment shown in FIG. 2, the transaction 212 that is handled the next day is copied to the replication data base 25 that was created. After the disk separation 27, the transaction processing 22F to be handled on that day is executed, and hence the transaction 215 corresponding to that processing 22F is copied to the data base 24. However, since the disks have been separated, the transaction 215 is not copied to the replication data base 25. Here, the transaction that is handled on that day means, for example, a transaction having a column C1 value in a table TA which is updated to a value of 20031016 or below (see FIG. 3).

When the user requests the transaction selection processing 29 to the data base management system 111 under the current situation, the transaction 212 that is handled the next day is cancelled from the replication data base 25, and the transaction 215 that is handled on that day is added to the replication data base 25, thus making it possible to create a replication data base 25 in which just the transaction processing to be handled on that day is completed. It should be noted that the request of the transaction selection processing 29 may be automatically made, for example after the execution of the staticization release processing 28, by the data base management system 111. Moreover, the online application 112 may determine the completion of the work 217 that is handled on that day, and may make the transaction selection processing 29 request.

FIG. 3 shows a configuration and a content of an update log file 23 of the transactions that were executed in accordance with the time chart of FIG. 2. The record of the update log file 23 is listed in each operation and in time sequence. The execution result of each operation includes update time 31, log sequence number 32, transaction ID 33, operation cord 34, and update information 35. The update information 35 includes table name 351, column number 352, and column information 353 of 352 columns. The column information 353 includes column name 3531, data length 3532, pre-update data 3533, and post-update data 3534. The internal time of the computer executing the operation is registered as the update time 31, for example. On the other hand, the time stamp written as post-update data in a prescribed location of the INSERT log (for example, a location having a prescribed table name and a prescribed column name) is the time stamp that is attached by the data base management system 111 or the online application 112.

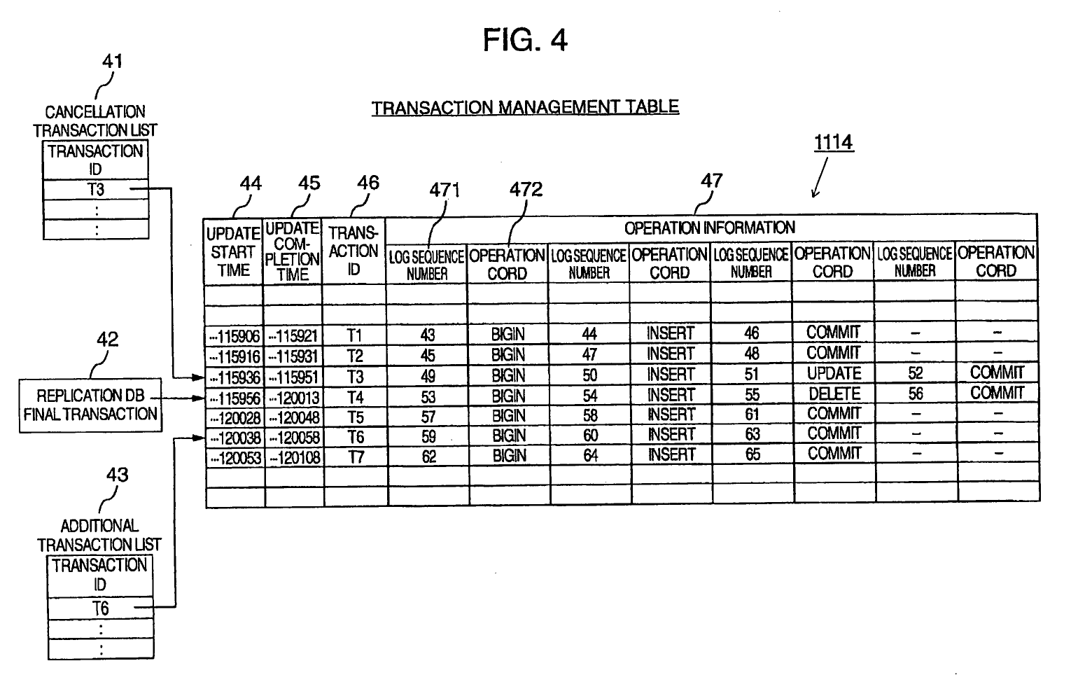

FIG. 4 shows a transaction management table 1114 and content thereof, in which the record of the update log file of transaction, which is performed in accordance with the time chart of FIG. 2, is rearranged in transactions in stead of in operations. The transaction management table 1114 includes update start time 44, update completion time 45, transaction ID 46, and operation information 47. The operation information 47 includes log sequence number 471 and operation cord 472 in which only the number of relevant transactions is recorded. A transaction ID of the last updated transaction of the replication data base 25 is stored in a replication DB final transaction 42. A transaction ID of a transaction which is cancelled from the replication data base 25 is stored in a cancellation transaction list 41. A transaction ID of a transaction added to the replication data base 25 is stored in an additional transaction list 43. At least one of the cancellation transaction list 41, the replication DB final transaction 42, and the additional transaction list 43 is held in the data base management system 11.

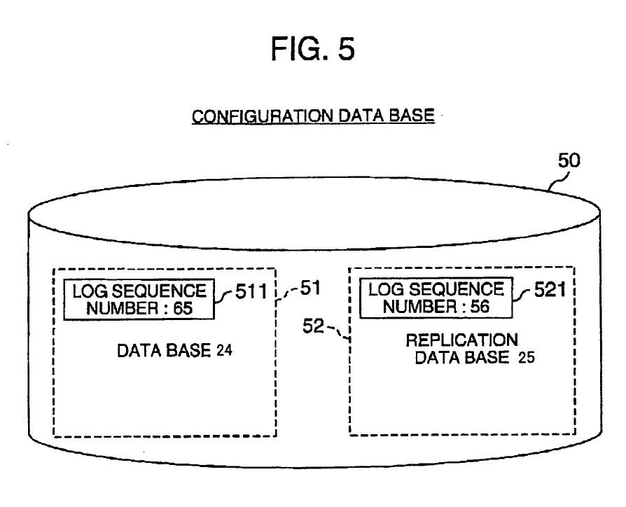

FIG. 5 shows a configuration and update content of a data base which is updated in accordance with the time chart of FIG. 2. An external storage device 16 includes a logical volume 51 for storing a data base 24, and a logical volume 52 for storing a replication data base 25. In the logical volume 51 for storing the data base 24, a log sequence number 511 of an operation with which the data base 24 is last updated, is stored. In the logical volume 52 for storing the replication data base 25, a log sequence number 521 of an operation with which the replication data base 25 is last updated, is stored.

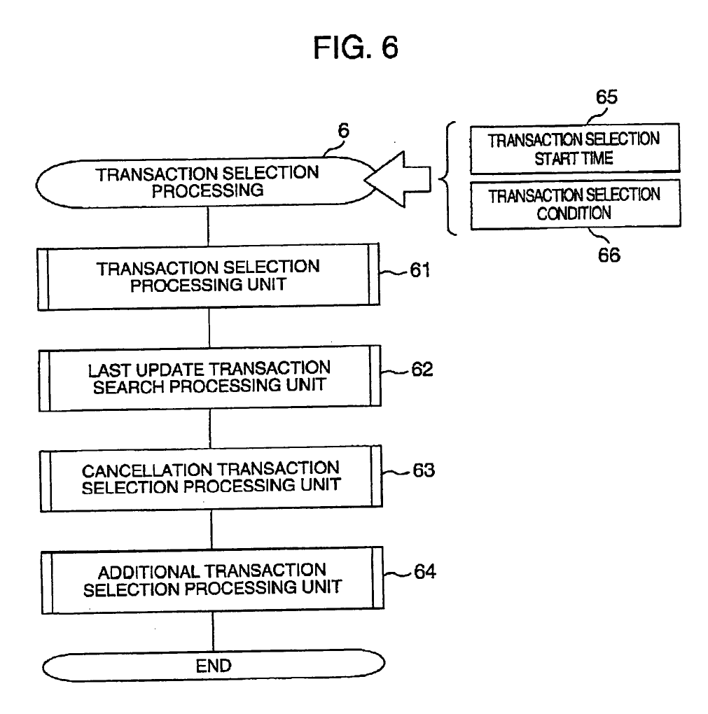

FIG. 6 shows a flow of transaction selection processing. The transaction selection processing comprises: a transaction selection start time 65; a step 61 of selecting a transaction assuming a transaction selection condition 66 (for example, information indicating year/month/day) as input information; a step 62 of searching a last updated transaction; a step 63 of selecting a cancelled transaction; and a step 64 of selecting an additional transaction.

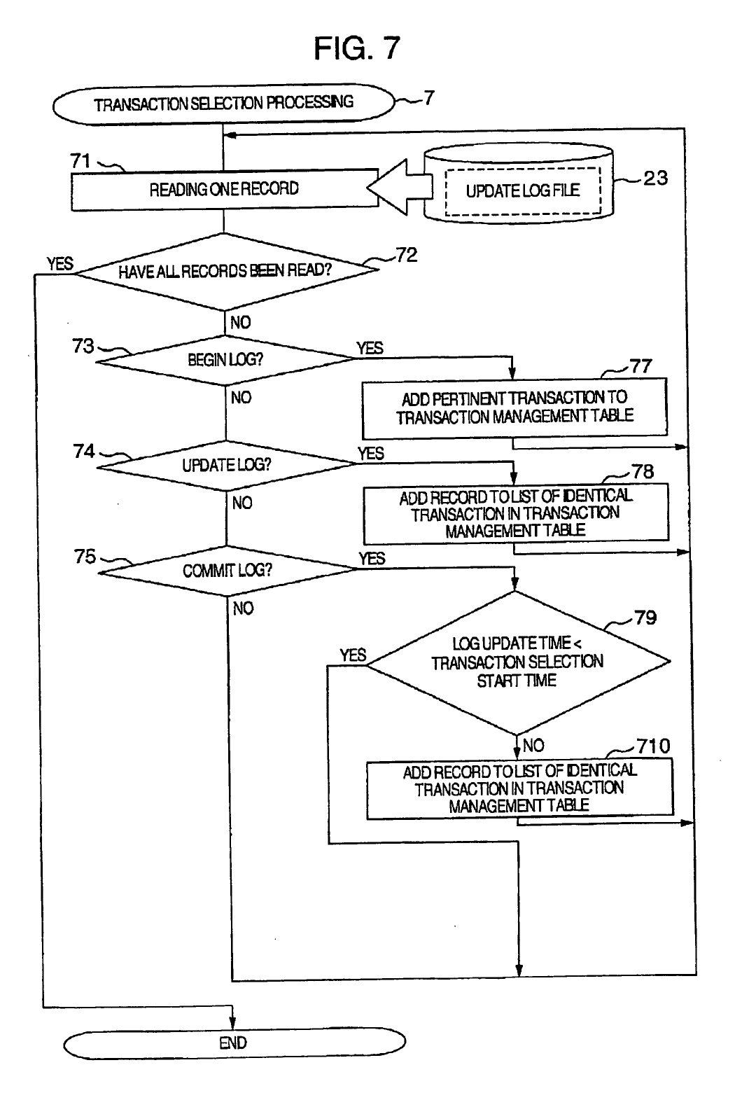

FIG. 7 shows a flow of transaction selection processing. This processing can be executed by the transaction selection processing unit 11111.

The transaction selection processing unit 11111 first reads one record from an updated log file 712 (step 71). A determination is made as to whether all have been read out (step 72). If so, the processing terminates.

The transaction selection processing unit 11111 determines whether an operation record 34 of the read out record is a BEGIN log (step 73). If so (YES at step 73), then information relating to a relevant transaction (for example, update start time, transaction ID, log sequence number and operation code) is added to the transaction management table 1114 (step 77).

If it is an updated log (YES at step 74), then the transaction selection processing unit 11111 adds a record (for example, a log sequence number and operation code) to the row of the same transactions in the transaction management table 1114 (step 78).

If it is a COMMIT log (YES at step 75), the transaction selection processing unit 11111 makes a comparison between the update time 31 of the corresponding COMMIT log and a transaction selection start time 65 (step 79). If the log update time is smaller than the transaction selection start time, then the transaction selection processing unit 11111 deletes the list of the same transactions in the transaction management table 1114 (step 711). If the log update time is the same as or larger than the transaction selection start time, then the transaction selection processing unit 11111 adds a record to the row of the same transactions in the transaction management table 1114 (step 710).

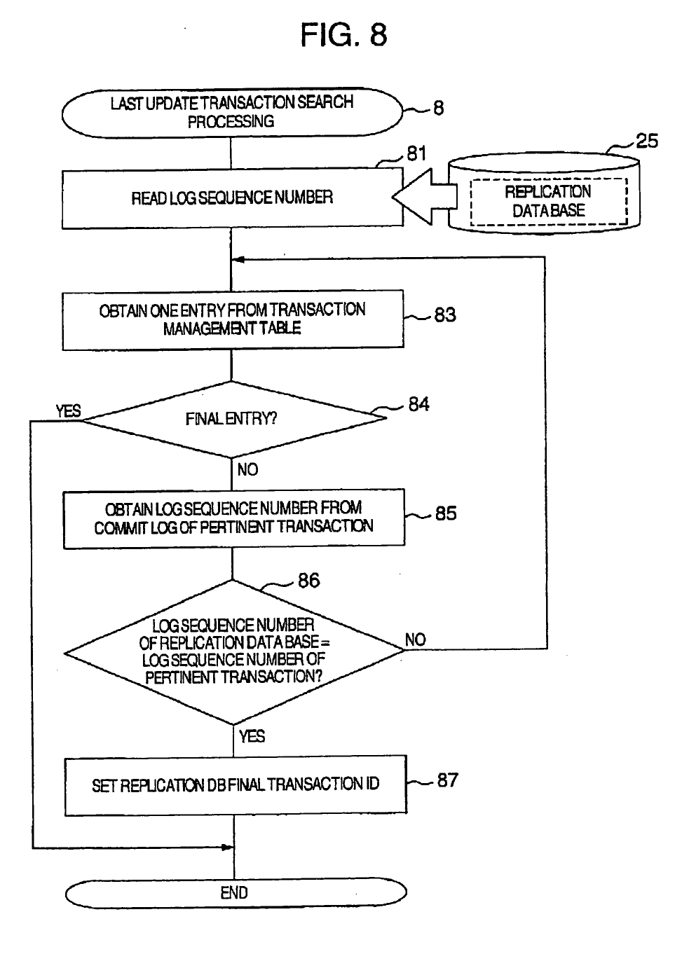

FIG. 8 shows a flow of processing for searching a transaction ID of the transaction which is last updated in the replication data base.

This processing can be executed by the last updated transaction search processing unit 11112.

First, the last updated transaction search processing unit 11112 reads in a log sequence number 521 from a replication data base 25 (step 81).

Next, the last updated transaction search processing unit 11112 retrieves record groups (lines) relating to transactions, one by one, from the transaction management table 1114 (step 83). If the retrieved record group is a final record (step 84), then the last updated transaction search processing unit 11112 terminates processing.

The last updated transaction search processing unit 11112 obtains a sequence number 471 of a COMMIT log from the retrieved record groups (step 85). If the retrieved log sequence number does not match a log sequence number 521 in the replication data base 25 (NO at step 86), then the last updated transaction search processing unit 11112 returns to step 83. If a match is found (YES at step 86), then the last updated transaction search processing unit 11112 sets the ID of the relevant transaction as a replication DB final transaction 42 (step 87).

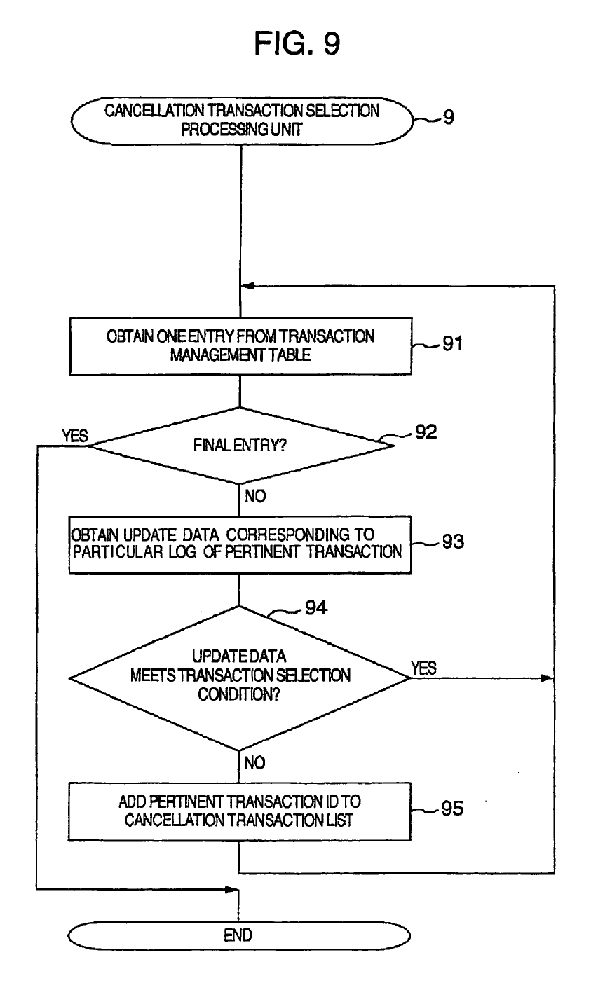

FIG. 9 shows a flow of processing for selecting a transaction to be cancelled from the replication data base.

This processing can be executed by the cancellation transaction selection processing unit 11113.

First, the cancellation transaction selection processing unit 11113 retrieves the record groups prior to the record group containing the transaction ID set as the replication DB final transaction 42, one by one, from the management table 1114 (step 91). If the retrieved record group is a final entry (step 92), the processing terminates.

The cancellation transaction selection processing unit 11113 acquires a log corresponding to INSERT and UPDATE operations, of the logs of operations that are performed by the transaction corresponding to the retrieved record group, and it acquires update information corresponding to the sequence number of the acquired log (for example, row information including the post-update data), from the update log file 23 (step 93). The cancellation transaction selection processing unit 11113 judges whether or not the acquired update information satisfies an input transaction selection condition 66 (see FIG. 6), and if it does satisfy the condition (step 94), then the processing returns to step 91. If it does not satisfy the condition, then the cancellation transaction selection processing unit 11113 adds the transaction ID corresponding to the acquired update information to a cancellation transaction list 41 (step 95) and then returns to step 91.

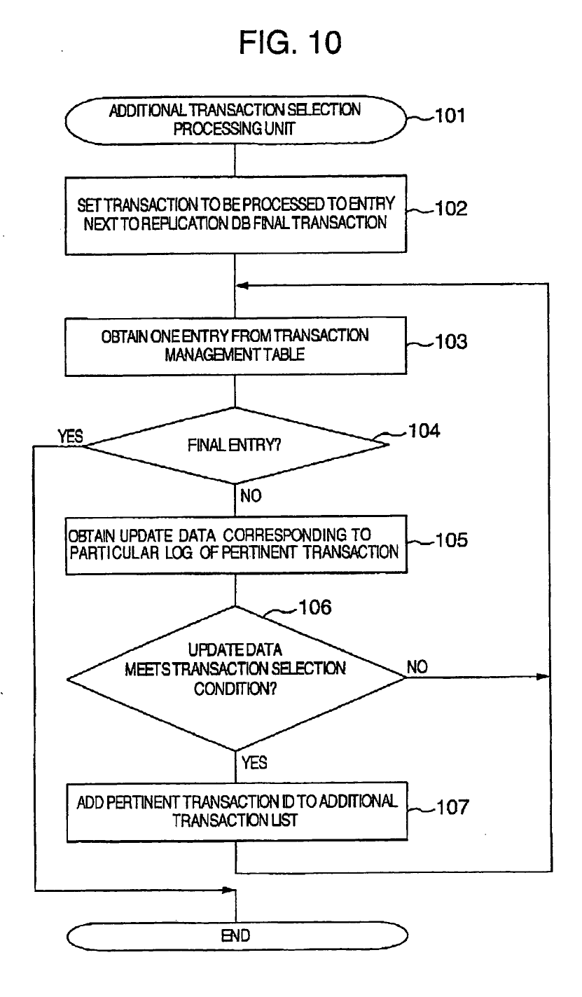

FIG. 10 shows a flow of processing for selecting transactions to be added to the replication data base.

This processing can be executed by the additional transaction selection processing unit 11114.

First, the additional transaction selection processing unit 11114 searches the transaction management table 1114 for the next record group (entry) following the record group containing the transaction ID set as the replication DB final transaction ID 42 (step 102), and it retrieves the record groups, one by one (step 103). If the retrieved record group is a final entry (step 104), then the processing terminates.

The additional transaction selection processing unit 11114 acquires a log corresponding to INSERT and UPDATE operations, of the logs of operations that are performed by the transaction corresponding to the retrieved record group, and it acquires update information corresponding to the sequence number of the acquired log from the update log file 23 (step 105). The additional transaction selection processing unit 11114 judges whether or not the acquired update information satisfies a transaction selection condition 66, and if it does not satisfy the condition (NO at step 106), then the processing returns to step 103. If it does satisfy the condition (YES at step 106), then the additional transaction selection processing unit 11114 adds the transaction ID corresponding to the acquired update information, to an additional transaction list 43 (step 107) and then returns to step 103.

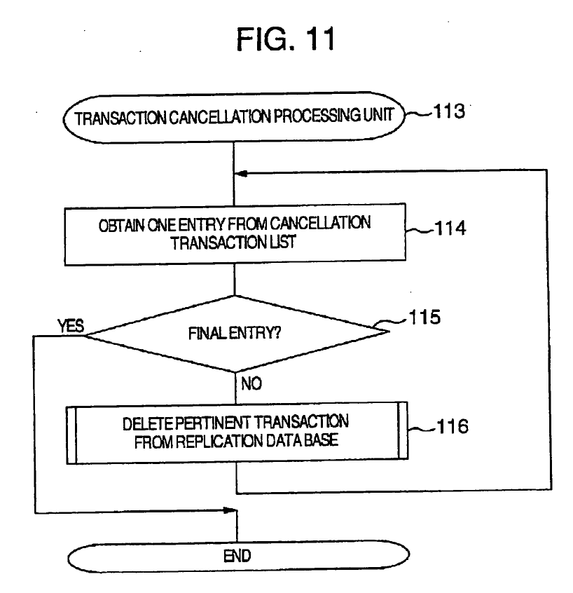

FIG. 11 shows a flow of processing for canceling transaction from a replication data base.

This processing can be executed by the transaction cancellation processing unit 1112.

First, the transaction cancellation processing unit 1112 obtains one transaction ID from a cancellation transaction list 41 (step 114). If it is a final entry, the processing terminates (step 115). The transaction cancellation processing unit 1112 cancels the transaction corresponding to the obtained transaction ID from the replication data base 25 (step 116), and then returns to step 114.

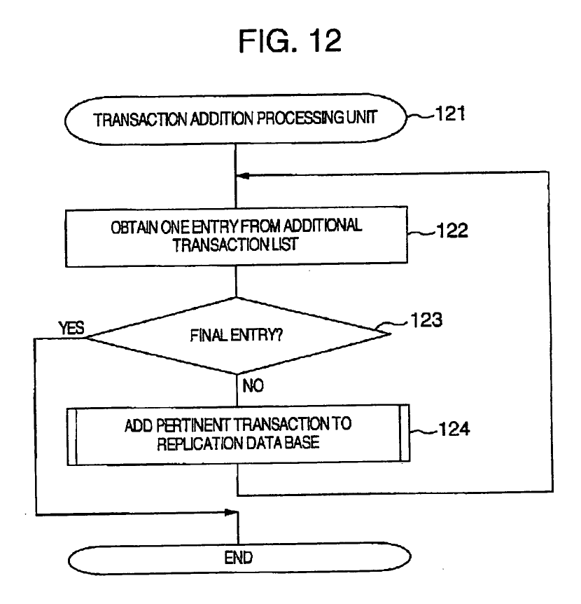

FIG. 12 shows a flow of processing for adding transaction to the replication data base.

This processing can be executed by the transaction addition processing unit 1113.

First, the transaction addition processing unit 1113 obtains one transaction ID from the additional transaction list 43 (step 122). If it is a final entry, the processing terminates (step 123). The transaction addition processing unit 1113 executes the operations of the transactions corresponding to the retrieved transaction IDs, one by one, copies specific update contents of the data base 24 (for example, transactions to be handled on the next day following disk separation) to the replication data base 25 (step 124), and then returns to step 122.

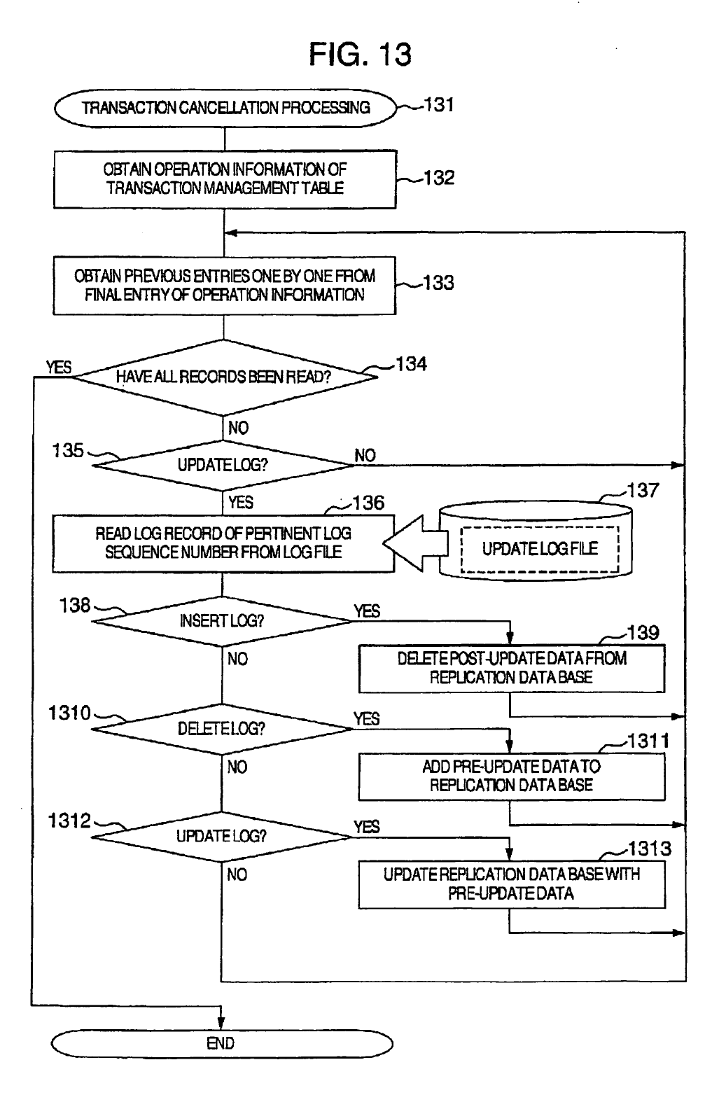

FIG. 13 shows a flow of processing for canceling one transaction from the replication data base.

This processing is one example of specific processing carried out in step 116 in FIG. 11.

First, the transaction cancellation processing unit 1112 obtains operation information 47 of the relevant transaction (the transaction corresponding to the transaction ID acquired at step 114 in FIG. 11) from the transaction management table 1114 (step 132). Next, the transaction cancellation processing unit 1112 obtains entries, one by one, from behind the operation information 47 (in other words, from the entries having the larger log sequence number in that operation information 47) (step 133). When all entries are processed (step 134), the processing terminates.

When the operation cord 472 of an obtained entry is other than INSERT, DELETE, or UPDATE (step 135), the transaction cancellation processing unit 1112 returns to step 133.

Next, the transaction cancellation processing unit 1112 obtains a log record corresponding to the log sequence number 471 of the obtained entries, from an update log file 137 (step 136). When the log corresponding to the obtained log record is an INSERT log (step 138), the transaction cancellation processing unit 1112 DELETES the post-update data 3534 from the replication data base 25 (step 139), and then returns to step 133.

When the log corresponding to the obtained log record is a DELETE log (step 1310), the transaction cancellation processing unit 1112 INSERTS pre-update data 3533 into the replication data base 25 (step 1311), and then returns to step 133.

When the log corresponding to the obtained log record is an UPDATE log (step 1312), the transaction cancellation processing unit 1112 UPDATES the data in the replication data base 25 with the pre-update data 3533 (step 1313), and then returns to step 133.

The first embodiment has been described in the above, and advantages thereof will be described in the following sections.

First, when utilizing the replication data base for various purposes, including batch processing, back up, or the like, it is possible to significantly reduce the burden of data preparations required of the application. More specifically, the transaction selection processing 29 makes it possible to change an update state of the once created replication data base in accordance with an arbitrary condition. For example, it is possible to cancel the already updated content of the batch processing, which is handled the next day, after the replication data base is made. Conversely, it is also possible to copy the update content of the batch processing, which is handled on that day and is not copied yet, to the replication data base.

Second, operational flexibility will be enhanced. For example, even in the event that works to be handled on that day and works to be handled the next day are mixed, since working hours can not be clearly separated, the transaction selection processing 29 makes it possible to create a replication data base in which the processing of the works to be handled on that day is in a state of completion. Moreover, the state of the replication data base can be changed any number of times at arbitrary times.

Third, the state of the replication data base can be changed without affecting the online work. This is because the transaction selection processing 29 updates the replication data base using the information written to the update log file 23.

According to the first embodiment described above, at least one of these three advantages can be achieved.

### Embodiment 2

A description will be given below to embodiment 2, in which selection of transaction, and update processing of the replication data base are performed by an external storage device in stead of an information processing apparatus.

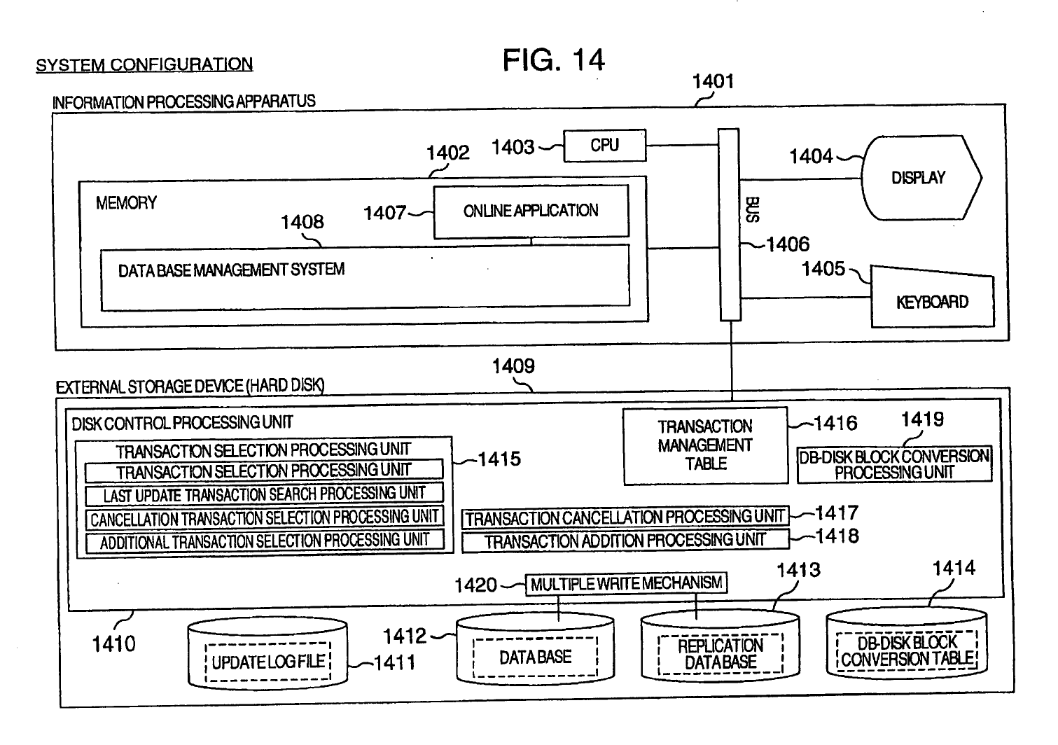

FIG. 14 shows a configuration of an information processing apparatus of embodiment 2 according to the present invention. In the embodiment, a system is implemented by an information processing apparatus 1401 and an external storage device 1409, which are connected by a bus 1406. The information processing apparatus 1401 comprises: a CPU 1403; a memory 1402; a display 1404; and a keyboard 1405. An online application 1407 on the memory 1402 accesses a data base 1412 on the external storage device 1409 via a data base management system 1408. The update content of the data base 1412 can be recorded on an update log file 1411 as update history information, and copied to a replication data base 1413 by a multiple write mechanism 1420 on a disk control processing unit 1410. The multiple write mechanism 1420 can also release the multiple write at an arbitrary point in time, and allows the replication data base 1413 to be read and written as a data base that is independent from the data base 1412 via the data management system 1408. The data base management system 1408 includes: a transaction selection processing unit 1415 for selecting a transaction that meets a certain condition from the update log file 1411; a transaction management table 1416 for managing the transaction; a transaction cancellation processing unit 1417 for canceling the transaction that does not meet the condition from the replication data base 1413; and a transaction addition processing unit 1418 for adding the transaction that meets the condition to the replication data base 1413. When updating the content of transaction processing, which is performed to the replication data base 1413, the transaction cancellation processing unit 1417 and transaction addition processing unit 1418 use a DB-disk block conversion table 1414 which indicates a relative relationship between logical position information of a transaction, which is recognized by data base processing on the information processing apparatus 1401 side, and physical position information on the external storage device 1409 to convert the position information indicated in the update log file 1411 to physical position information on the external storage device 1409. Then, they update the data of the replication data base 1413 on the external storage device 1409, which is represented by the converted physical position information, in accordance with the content of the update log file 1411. The DB-disk block conversion processing unit 1419 utilizes the DB-disk block conversion table 1414 as conversion information.

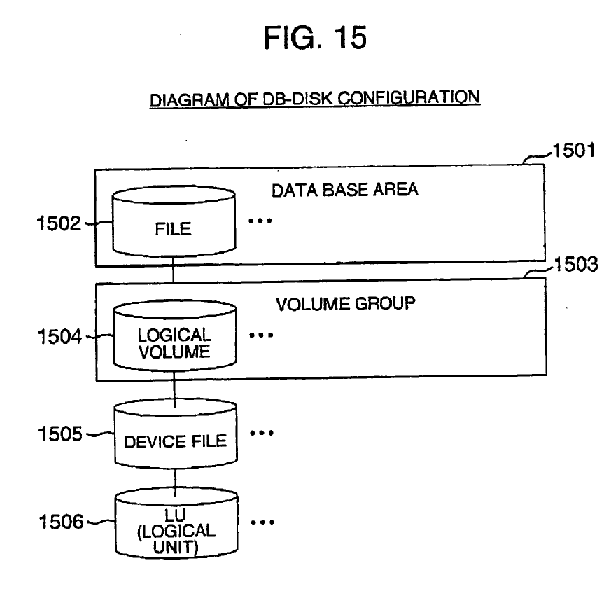

FIG. 15 is a diagram showing a relationship between logical information of a DB and physical information of a disk. More specifically, it is a diagram showing an example of a relationship of a data base area which is recognized on the information processing apparatus 1401, a logical volume 1504 which is recognized by an operating system, and mapping of a device file 1505 on an LU 1506 within the external storage apparatus 1409. As FIG. 15 shows, in the data base management system 1408, a data base area 1501 where data is stored is recognized to comprise a plurality of files 1502. Each constituent file 1502 corresponds to the file of an operating system on the information processing apparatus 1401. In FIG. 15, a case is assumed in which it is recognized as a RAW device in the operating system. Moreover, the file of the operating system is managed as a device file 1505 that corresponds to a physical magnet disk device, and the device file is mapped to a LU (Logical Unit) 1506 that corresponds to each magnetic disk device within the external storage device 1409, as described above.

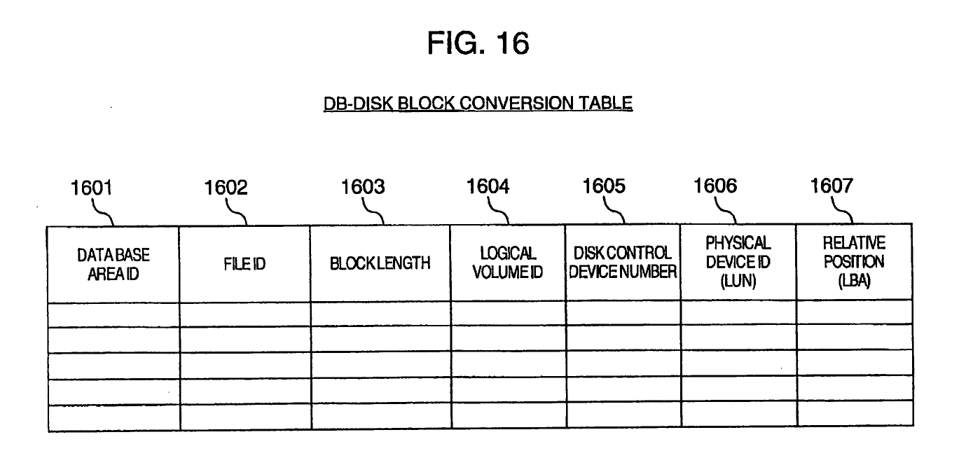

FIG. 16 shows a configuration of a DB-disk block conversion table. As FIG. 16 shows, the DB-disk block conversion table 1414 includes: data base area ID 1601 for identifying a data base area 1501; file ID 1602 for indicating the sequence number of files when the data base area, which is identified by the data base ID, comprises a plurality of files; block length 1603 for indicating the length of a block that constitutes the foregoing data base area; a logical volume ID 1604 that is information for identifying the logical volume, in which the file that constitutes the foregoing data base area is secured; disk control device number 1605 that is a number for identifying an external storage device to which a logical volume is mapped that is identified by the logical volume ID; physical device ID 1606 that is information for identifying a drive number of a magnetic disk device, to which the logical volume is mapped, in the magnetic disk device of the external storage device which are identified by the disk control device number; and relative position 1607 for indicating a relative position of a relevant file on the magnetic disk device which is identified by the physical device ID.

In the external storage device 1409, the device file 1505 corresponds to the LU 1506. Therefore, the file, which constitutes the data base area 1501, is finally mapped to a magnetic disk device which is a physical device. Corresponding physical information is a physical device ID for identifying a physical device on the external storage device 1409, and an LBA (Logical Block Address), which is a relative position within the physical device.

Next, a description will be given to a difference in the flow of processing between the first embodiment and the second embodiment. While in the first embodiment, the transaction selection processing 1415 was operated on the information processing apparatus 1401 side by the transaction selection processing activation 29, in the second embodiment, it is operated on the external storage device 1409. Furthermore, in update processing of the replication data base 1413 in the transaction cancellation processing unit 1417 and transaction addition processing unit 1418 (step 116, and step 124), logical position information, which is indicated in the update log file 1411, is converted to physical position information on the external storage device 1409 by referring to the DB-disk block conversion table 1414 shown in FIG. 16 and identifying a disk control device number of a corresponding disk, a drive number, and a page number. Then, the data of the replication data base 1413 on the external storage device 1409, which is represented by the converted physical position information, is updated in accordance with the content of the update log file 1411. More specifically, the DB-disk block conversion table 1414 is searched for a file ID which is included in the pertinent log information and a record that matches the data base area ID to acquire a pertinent disk device number, drive number, and relative position. Thereafter, assuming the relative position is the head of the file, the page number of the log information is converted to the page number on the physical disk.

According to the information processing apparatus described in the second embodiment, when updating the replication data base by the transaction selection processing 29, not only the burden of input/output processing between the information processing apparatus and external storage device, but also the amount of memory resource consumed by the information processing apparatus and the usage of CPU are reduced, thus making it possible to minimize the effect on online work.

### Embodiment 3

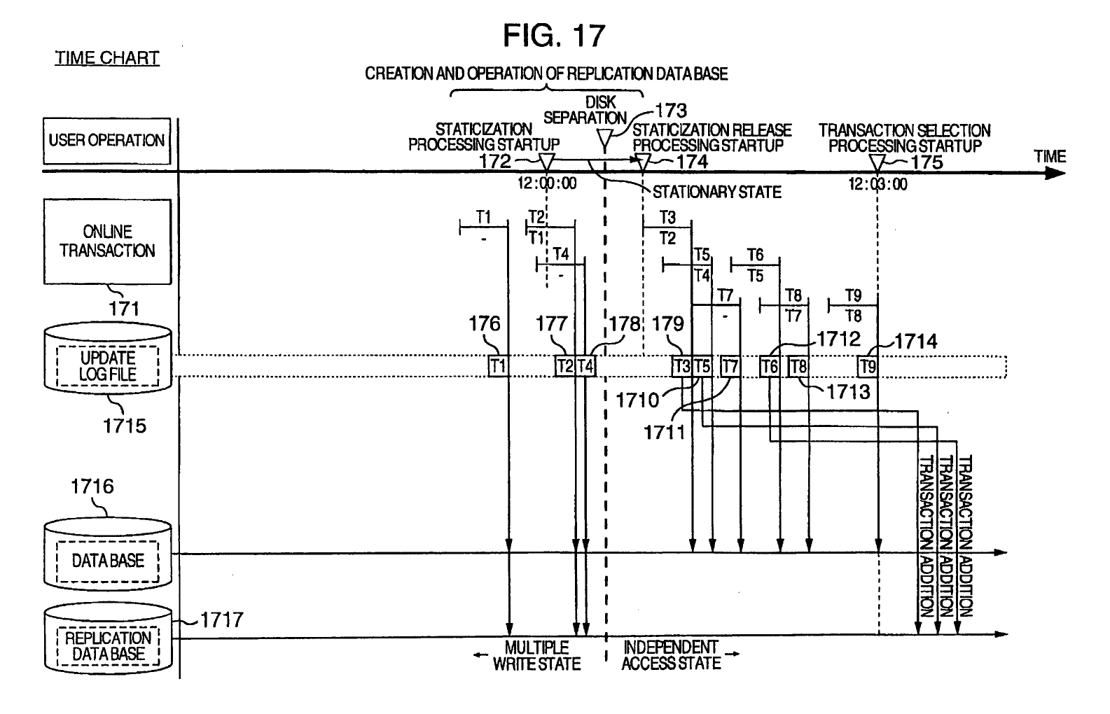

FIG. 17 is another time chart of the first embodiment according to the present invention. The embodiment shows a case in which there is an association between transactions in an online transaction 171. More specifically, a transaction T2 (177) performs processing based on the result of processing of a transaction T1 (176), and a transaction T3 (179) performs processing based on the result of processing of the transaction T2 (177). In such operations, if a replication 1717 of a data base 1716 is created by creating and operating the replication data base at an arbitrary time (steps 172, 173, and 174), some of the associated transactions may not be copied to the replication data base, thus making it impossible to assure the association between the transactions on the replication data base side.

In the present embodiment, the association between transactions on the replication data base side is assured by following processing steps. When the associated transactions are performed before the replication DB final transaction 42 in a transaction selection condition 66 determination step 106 of an additional transaction selection processing unit 11114, a pertinent transaction is selected as an additional transaction. Optionally, when associated transactions are performed later than the replication DB final transaction 42 in a transaction selection condition 66 determination step 94 of a cancellation transaction selection processing unit 11113, a pertinent transaction is selected as a cancellation transaction.

Above described information processing apparatus of the third embodiment pays attention to the association between transactions to copy the associated transactions to the replication data base without separating them. Thus, it becomes possible to assure the association between transactions on the replication data base side.

### Embodiment 4

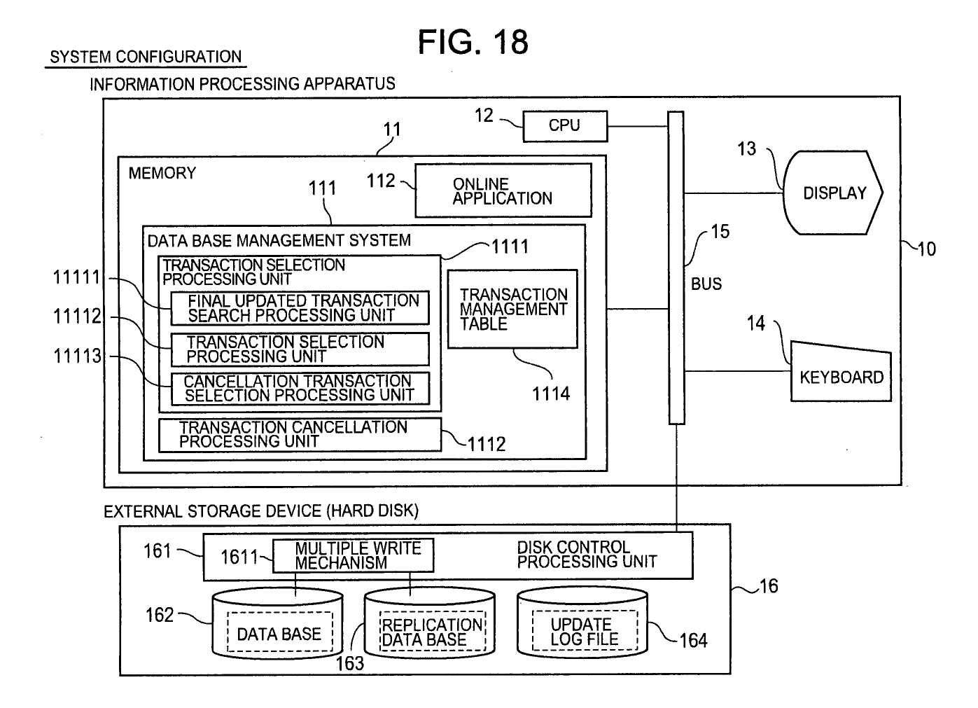

FIG. 18 is a compositional diagram of a data processing system relating to a fourth embodiment of the present invention.

In this fourth embodiment, in contrast to the first embodiment described above, there is not requirement for processing which adds to the replication data base 25 a transaction which has been copied to the data base 24 but has not yet been copied to the replication data base 25, (namely, roll-forward processing). Therefore, in this fourth embodiment, it is not necessary to install an additional transaction selection processing unit 11114 or a transaction addition processing unit 1113 as elements relating to transaction addition processing. Consequently, a contribution can be made to saving computer resources and reducing the processing burden on the computer.

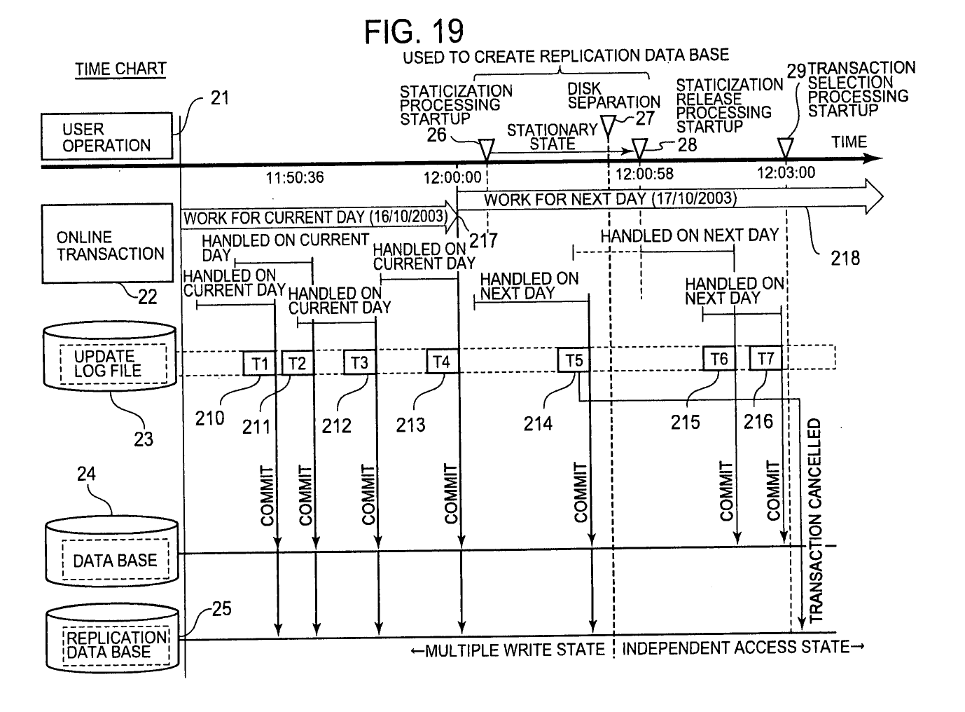

FIG. 19 shows one example of a processing sequence executed by a data processing system relating to a fourth embodiment of the present invention.

In this fourth embodiment, the time band of the work for that day and the time band for the work for the next day do not overlap, but rather, they are divided at a prescribed reference time boundary (for example, 0:00:00 (hr: min: sec)). However, The start time and completion time of transaction processing handled on the current day and/or the start time and completion time of transaction processing handled on the next day may span this reference time.

In this case, even if the reference time is exceeded, provided that the data base 24 and the replication data base 25 are synchronized after a short while (provided that a disk separation 27 is not implemented), then both the data base 24 and the replication data base 25 will contain a mixture of transactions handled on that day 210 to 213 and a transaction to be handled on the next day 214.

If a transaction selection processing startup 29 is executed after transactions handled on that day 210 to 213 and a transaction to be handled on the next day 214 have become mixed in the replication data base 25, then the transaction selection processing unit 111 is started up and the following processing is carried out.

Firstly, a transaction selection start time 65 and a transaction selection condition 66 are input to the transaction selection processing unit 111. At least one of the transaction selection start time 65 and the transaction selection condition 66 are conditions input by the user, for example. These conditions may be input and stored previously, or they may be input when the transaction selection processing is started up.

Thereupon, transaction selection processing is carried out. In this processing, for example, the transaction selection processing unit 11111 adds the COMMIT log generated before the transaction selection start time 65, to the record group (row) of the same transactions in the transaction management table 1114, and it deletes the transactions containing the COMMIT log generated after the transaction selection start time 65, from the transaction management table 1114. In other words, of the plurality of transactions, the transaction selection processing unit 11111 focuses on transactions that were completed before the transaction selection start time 65.

Next, last updated transaction search processing is carried out. In this processing, for example, the last updated transaction search processing unit 11112 obtains the log sequence number stored in the replication data base 25, and if it is able to identify a COMMIT log having the same number as that log sequence number, then it establishes the ID of the transaction containing that log sequence number as the replication DB final transaction ID.

Next, cancellation transaction selection processing and transaction cancellation processing are carried out. In this processing, for example, the cancellation transaction selection processing unit 11113 obtains the record group corresponding to the ID before the established replication DB final transaction ID, and it sets a transaction ID corresponding to the input transaction selection condition (for example, 17 Oct. 2003). The transaction cancellation processing unit 1112 deletes the transaction corresponding to the established ID from the replication data base 25. Here, the transaction cancellation processing unit 1112 is also able to implement roll-back processing on the basis of the information recorded in the update log file 23. In other words, the transaction cancellation processing unit 1112 is able to restore the pre-update data to the replication data base 25, on the basis of the update information 35, and the like, recorded in the update log file 23.

By means of the aforementioned sequence of processing, it is possible to leave only those transactions desired by the user (for example, the transactions handled on that day), in the replication data base 25.

In this fourth embodiment, the time in a timing table is used as the time stamp recorded as the post-update data in the INSERT log, rather than the time indicated by a timer in the computer (for example, a timer managed by the CPU 12 of the information processing device 10). A concrete example is described below.

FIG. 20 is an illustrative diagram of a method for creating a separation point between data represented by a time series in a data base, by using a timing table.

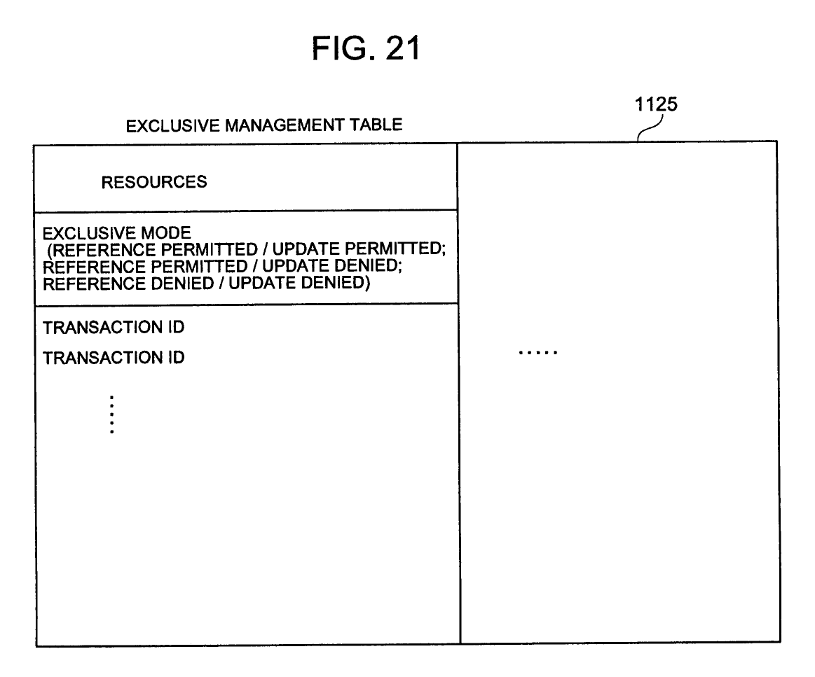

In the processing described with reference to this diagram, an exclusive management table is referenced. Resource-related information, an exclusive mode, and a waiting transaction ID are recorded for each resource in the exclusive management table 1215, as shown in FIG. 21, for example. The resource-related information is information which indicates the object of exclusive management. For example, in the case of exclusive management with respect to a timing table 1214, information for specifying the timing table 1214 is stated as the resource-related information. There are a plurality of exclusive statuses, for example, “reference permitted/update permitted” which means a state where both reference and updating are possible, “reference permitted/update denied” which means a state where reference is possible but updating is impossible, and “reference denied/update denied” which means a state where both reference and updating are impossible. The waiting transaction ID is recorded in a queue format, for example. If a second transaction ID has been recorded before the first transaction ID, then the transaction corresponding to the second transaction ID is able to refer to or update the timing table, before the transaction corresponding to the first transaction ID.

Referring again to FIG. 20, transaction A is started up (step S1000), refers to the exclusive management table (S1001), and if it detects that the timing table 1214 is in a reference permitted state, then it refers to the timing table 1214 (S1002). Transaction A establishes a reference permitted/update denied status in the exclusive management table 1215, and acquires the time code stated in the timing table 1214 (for example, 2003/10/16).

Here, it is supposed that a time update timing is reached (in other words, the date changes) during processing of transaction A, and that a transaction for executing processing for updating the time code of the timing table 1214 (hereinafter, called “timing update transaction”) has been started up (S1010). The timing update transaction refers to the exclusive management table 1215 (S1011), but since a reference permitted/update denied status has already been set for the timing table 1214 in the exclusive management table 1215, then it records its own transaction ID in the exclusive management table 1215 and then waits for the exclusive status to be released.

Furthermore, it is also supposed that transaction B, which is a separate transaction from transaction A and the timing update transaction, has started up during processing of transaction A (S1020). Transaction B refers to the exclusive management table 1215 (S1021), but since a reference permitted/update denied status has already been set for the timing table 1214 in the exclusive management table 1215, then it records its own transaction ID in the exclusive management table 1215 and then waits for the exclusive status to be released.

If processing of transaction A has been established, then a COMMIT is issued (S1003), which releases the exclusive status of the timing table 1214.

Furthermore, the timing update transaction also becomes able to refer to the timing table 1214. This is because the ID of the timing update transaction was recorded in the exclusive management table 1215 before the ID of transaction B. The timing update transaction refers to the timing table 1214 (S1012), and establishes a reference denied/update denied status in the exclusive management table 1215. The timing update transaction writes the required portion of the time indicated by the timer in the computer (for example, the year, month and day if the time is expressed in terms of year, month, day and seconds), as a new time code, over the time code that was previously written in the timing table 1214 (S1013). The processing of the timing update transaction is then established, a COMMIT is issued (S1014), and the exclusive status is released.

When the exclusive status is released, transaction B, which is reserved next in the exclusive management table 1215, references the timing table (S1022). Transaction B establishes a reference permitted/update denied status in the exclusive management table 1215, and obtains a new time code (for example, 2003/10/17) stated in the timing table 1214. Processing of transaction B is then established and a COMMIT is issued (S1023).

By means of this sequence of processing, it is possible to cancel a transaction having a COMMIT log which is after the COMMIT log of the timing update transaction.

A fourth embodiment was described above. In this fourth embodiment, startup of data staticization processing 26 (see FIG. 19) may be implemented at a time that is sufficiently later than the boundary between the first time band (for example, the time band handled on that day) and the second time band (for example, the time band handled on the next day). In this way, although a greater number of transactions to be handled on the next day are stored in the replication data base 25, the transactions handled on that day are copied reliably to the replication data base 25.

Various preferred embodiments of the present invention were described above, but these are merely examples for explaining the present invention, and the scope of the present invention is not limited in any way to these embodiments. The present invention may be implemented in various other modes.

1. A data processing method in a data processing apparatus that has a storage device (16) having a replication generation function for replicating a data base (162) to create a replication data base (163), and stores in said storage device data, and a plurality of log information in transaction processing which utilizes said data, wherein
after synchronization between said data base and said replication data base is released, a transaction is selected that is performing a data operation to said replication data base without meeting a predetermined condition, and processing for canceling said data operation is performed to said replication data base with said selected transaction; or
a transaction is selected that meets said predetermined condition, and is not performing the data operation to said replication data base, and the data operation is performed with said selected transaction to said replication data base.

2. The data processing method according to claim 1, wherein said predetermined condition means that the time of a timestamp included in a processing request, which is received by the data processing apparatus that originally generates said transaction, is before the predetermined time.

3. The data processing method according to claim 1, wherein said data operation, which is performed or cancelled after said synchronization is released, uses said log information that is generated in the processing of said selected transaction.

4. The data processing method according to claim 1, wherein said transaction is stored by associating an identifier of a sub-transaction derived from the processing result of said transaction with an identifier of said transaction, and a determination of said transaction is performed including said transaction and sub-transaction.

5. A data processing method in a storage device that has a replication generation function for replicating a data base to create a replication data base, and stores data and a plurality of log information in transaction processing that uses said data, wherein
a transaction is selected that is performing a data operation without meeting a predetermined condition after the synchronization between said data base and said replication data base is released, and cancellation processing of the data operation is performed to said replication data base with said selected transaction, or
a transaction is selected that meets said predetermined condition and is not performing the data operation to said replication data base, and the data operation is performed to the replication data base with said selected transaction.

6. A data processing apparatus that has a storage device having a replication generation function for replicating a data base to create a replication data base, and stores data and a plurality of log information in transaction processing that uses said data in said storage device, said apparatus further comprising:
means for detecting the release of synchronization between said data base and said replication data base; and
means for, upon detection of the release of said synchronization, selecting a transaction that is performing a data operation to said replication data base without meeting a predetermined condition to perform the data operation cancellation processing to said replication data base with said selected transaction, or selecting a transaction that meets said predetermined condition and is not performing the data operation to said replication data base to perform a data operation to said replication data base with said selected transaction.

7. A storage device that has a replication generation function for replicating a data base to create a replication data base, and stores data and a plurality of log information in transaction processing that uses said data, said device further comprising:
means for releasing synchronization between said data base and said replication data base; and
means, when said synchronization is released, for selecting a transaction that is performing a data operation to said replication data base without meeting a predetermined condition to perform the data operation cancellation processing to said replication data base with said selected transaction, or selecting a transaction that meets said predetermined condition and is not performing the data operation to said replication data base to perform a data operation to said replication data base with said selected transaction.

8. A data processing program for causing a data processing apparatus, which has a storage device having a replication generation function for replicating a data base to create a replication data base, to function such that it stores data and a plurality of log information in transaction processing that uses said data, said data processing program further comprising:
a step of releasing said synchronization between said data base and said replication data base; and
a step, upon detection of the release of said synchronization, of selecting a transaction that is performing a data operation to said replication data base without meeting a predetermined condition to perform the data operation cancellation processing to said replication data base with said selected transaction, or selecting a transaction that meets said predetermined condition and is not performing a data operation to said replication data base to perform the data operation to said replication data base with said selected transaction.

9. A data processing program for causing a data processing apparatus, which has a storage device having a replication generation function for replicating a data base to create a replication data base, to function such that it stores data and a plurality of log information in transaction processing that uses said data, said data processing program comprising:
a step of releasing said synchronization between said data base and said replication data base; and
a step, upon releasing said synchronization, of selecting a transaction that is performing a data operation to said replication data base without meeting a predetermined condition to perform the data operation cancellation processing to said replication data base with said selected transaction, or selecting a transaction that meets said predetermined condition and is not performing a data operation to said replication data base to perform the data operation to said replication data base with said selected transaction.

10. A data processing apparatus that has a storage device which has a replication generation function for replicating a data base to create a replication data base, and stores data and a plurality of log information in transaction processing that uses said data, said apparatus further comprising:
means for detecting the release of synchronization between said data base and said replication data base; and
means for, upon detection of the release of said synchronization, selecting a transaction, in which the time of a timestamp carried by a work processing request is after the completion of the work processing and a data operation to said data base is being performed before the start of said synchronization, to perform the data operation cancellation processing to said replication data base with said selected transaction, or selecting a transaction, in which the time of the timestamp carried by the work processing request is before the completion time of said work processing request and a data operation to said data base is being performed after the release of said synchronization to perform a data operation to said replication data base with said selected transaction.

11. A data processing method, comprising:
a step of storing a first transaction belonging to a first time band in a first data base;
a step of storing said first transaction stored in said first data base, in a second data base which is synchronized with said first data base;
a step of storing a second transaction belonging to a second time band in said first data base;
a step of storing said second transaction stored in said first data base, in a second data base which is synchronized with said first data base;
a step of inputting condition information indicating a condition for belonging to the second time band; and
a step of deleting a second transaction which matches said input condition information, from said second data base.

12. The data processing method according to claim 11, further comprising:
a step of attaching a time stamp to a log relating to said first transaction and said second transaction, and recording the log attached with said time stamp in a prescribed storage region; and
a step of searching for a time stamp belonging to the second time band as indicated by said input condition information, from a plurality of time stamps attached respectively to a plurality of logs registered in said prescribed storage region;
wherein, in said deleting step, said second transaction is deleted from said second data base, by deleting the transaction corresponding to the log attached with the time stamp searched in said searching step, from the second data base.

13. The data processing method according to claim 11, comprising:
a step wherein a certain transaction refers to a timing table in which timings are recorded, if an exclusive status indicating that reference to said timing table is denied has not been established;
a step wherein, if a first timing belonging to said first time band is recorded in said timing table referred to by said certain transaction, then said certain transaction becomes said first transaction by acquiring said first timing;
a step wherein an exclusive status denying reference is established for said timing table, if said certain transaction has acquired said first timing;
a step wherein, if an exclusive status denying reference has been established for said timing table, then a first timing recorded in said timing table is updated to a second timing belonging to said second time band, in the required portion of the timing indicated by a timer;
a step of releasing the exclusive status denying reference which has been established for said timing table;
a step wherein another transaction refers to said timing table, if an exclusive status denying reference has not been established for said timing table; and
said other transaction becomes said second transaction by acquiring said second timing from said timing table.

14. The data processing method according to claim 11, wherein:
said first time band and said second time band are consecutive time bands;
the method further comprising:
a step of starting a staticized state which cancels the start of transaction processing, at or after the start of said second time band;
a step of releasing the synchronization between said first data base and said second data base, after the start of said staticized state; and
a step of terminating said staticized state after releasing said synchronization;
wherein a step of inputting condition information and said deleting step are executed after said staticized state has terminated.

15. The data processing method according to claim 14, wherein:
in the step of starting said staticized state, said staticized state starts after processing of the last first transaction.

16. A data processing apparatus, comprising:
means for storing a first transaction belonging to a first time band in a first data base;
means for storing said first transaction stored in said first data base, in a second data base which is synchronized with said first data base;
means for storing a second transaction belonging to a second time band in said first data base;
means for storing said second transaction stored in said first data base, in a second data base which is synchronized with said first data base;
means for inputting condition information indicating a condition for belonging to the second time band; and
means for deleting a second transaction which matches said input condition information, from said second data base.

17. The data processing apparatus according to claim 16, wherein
said data processing apparatus is a storage device capable of storing data; and
said storage device comprises said first data base and said second data base.

18. A data processing apparatus, comprising:
a storage region for storing at least one computer program; and
a processor which operates by reading in a computer program from said storage region;
wherein said processor:
stores a first transaction belonging to a first time band in a first data base;
stores said first transaction stored in said first data base, in a second data base which is synchronized with said first data base;
stores a second transaction belonging to a second time band in said first data base;
stores said second transaction stored in said first data base, in a second data base which is synchronized with said first data base;
inputs condition information indicating a condition for belonging to the second time band; and
deletes a second transaction which matches said input condition information, from said second data base.

19. A computer-readable computer program for causing a computer to execute:
a step of storing a first transaction belonging to a first time band in a first data base;
a step of storing said first transaction stored in said first data base, in a second data base which is synchronized with said first data base;
a step of storing a second transaction belonging to a second time band in said first data base;
a step of storing said second transaction stored in said first data base, in a second data base which is synchronized with said first data base;
a step of inputting condition information indicating a condition for belonging to the second time band; and
a step of deleting a second transaction which matches said input condition information, from said second data base.
